(19) United States
(12) Patent Application Publication
(10) Pub. No.: US 2003/0181230 A1
(43) Pub. Date: Sep. 25, 2003

(54) Broadus catching game system using communication network

(76) Inventor: Kazuyoshi Shimoda, Tokyo (JP)

Correspondence Address: HARNESS, DICKEY & PIERCE, P.L.C., P.O. BOX 828, BLOOMFIELD HILLS, MI, 48303, US

(21) Appl. No.: 10/363,334

(22) PCT Filed: Apr. 12, 2002
(86) PCT No.: PCT/JP02/03682

(30) Foreign Application Priority Data
Apr. 16, 2001 (JP) 2001-1169943

(51) Int. Cl. A63F 13/00

(52) U.S. Cl. 463/7

(57) ABSTRACT

A system comprises a computer that functions as a WWW game contents server and is connected with a plurality of Web terminals, which execute a program for a virtual prize-obtaining game, via the Internet to allow mutual communication therewith. From the computer to the Web terminal is transmitted primary decision information indicating whether or not to allow obtainment of virtual prizes to the game being executed. The primary decision information is either obtainment-disallowing information for preventing obtainment of the virtual prize from succeeding regardless of how operation is carried out during the game, or obtainment-allowing information for allowing obtainment of the virtual prize to succeed depending on how the operation is carried out. The primary decision information is generated according to a target prize-obtainment rate in a prize-obtainment-rate-setting table, using prize-obtainment-rate-adjusting means.

### TECHNICAL FIELD

The present invention relates to a game system for obtaining virtual prizes in which prize-obtaining games, such as catcher games provided in game centers etc., can be virtually enjoyed on a computer.

### BACKGROUND ART

In recent years, prize-obtaining games called catcher games have been gaining popularity in amusement facilities such as game centers. This prize-obtaining game is a game in which: many prizes are placed within a transparent showcase, one prize is carried to a predetermined outlet, and that prize is obtained. A manipulator capable of gripping a prize is used for carrying the prize. This manipulator is placed within the same showcase as the prizes and is manipulated by operations buttons provided outside the showcase. Usually, moving operation can only be made in two directions: the forward direction and the rightward direction. According to this operation, a two-dimensional, planar positioning operation is performed to move the manipulator right above the desired prize. Then, the machine switches to an automatic operation, and after lowering and performing a gripping operation, the manipulator moves to the outlet and opens itself up. Accordingly, if the positioning has been precisely made and the prize has been skillfully gripped, it is possible to obtain that prize from the outlet.

However, the probability of being able to obtain a prize, i.e., a prize-obtainment rate, is automatically adjusted appropriately, and the machine is set so that the players can always obtain only a proper amount of prizes. Accordingly, economically unprofitable situations for catcher-game companies due to too many prizes being obtained, and/or situations in which the game becomes unpopular to the players due to difficulty in obtaining prizes are skillfully avoided.

A usual way of adjusting the prize-obtainment rate is to slightly adjust the gripping power of the manipulator according to an actually-achieved prize-obtainment rate. More specifically, if the actually-achieved prize-obtainment rate, which is the ratio of the number of prizes that have already been obtained to the number of times the game has been executed, is higher than a target prize-obtainment rate, the manipulator's gripping power is weakened so that the prizes become harder to grip in order to lower the actually-achieved prize-obtainment rate. On the other hand, if the actually-achieved prize-obtainment rate is low, the above-mentioned gripping power is strengthened so that gripping becomes easier.

Incidentally, in recent years, there has been rapid development in the environment of communication networks, such as the Internet. In accordance therewith, by virtue of an increase in data-communication rate, it has also become possible to distribute an extremely large amount of data in a short time. Therefore, online games, such as the game of GO and Japanese chess on the Internet, that can be enjoyed anywhere as long as there is a terminal such as a personal computer (hereinafter referred to as a PC) are becoming widely popular.

According to such a background, by making it possible to play prize-obtaining games such as the above-mentioned catcher game on the Internet alike other games, since it will become possible to easily enjoy the game without the trouble of going to a game center, there is a possibility that such a game will become more popular than the actual catcher games in game centers.

The prize-obtainment rate of the above-mentioned catcher game in a game center can be adjusted anyhow by controlling the gripping power of the manipulator. However, a manipulator of a catcher game on the Internet is only a moving image displayed on a screen of the operating terminal, and therefore, it will not be possible to perform the above-mentioned controlling, and determination of whether a prize can be obtained or not will be only made according to the degree of a match between the position of the manipulator and the position of the prize. Therefore, if the player gets the knack of playing the game, there will be a possibility that the prizes will be obtained by the player without limit, and an economically unprofitable situation for the catcher-game company will occur. On the other hand, if the determination level for the degree of matching is made strict in order to prevent the above situation, it will be inevitable that a situation in which the game becomes unpopular to the players will occur. That is, with regards to a catcher game on the Internet, there is no measure for adjusting the prize-obtainment rate, and accordingly, there is a possibility that the game will be prevented from becoming popular.

The present invention has been contrived in view of such circumstances, and an object thereof is to provide a prize-obtaining game system, using a communication network, that enables a prize-obtaining game, which is usually provided in e.g. a game center, to be virtually enjoyed on e.g. a personal computer at home, and that is capable of adjusting the prize-obtainment rate of the game.

### DISCLOSURE OF INVENTION

In order to achieve the above and other objects, one aspect of the present invention is a prize-obtaining game system using a communication network, the game system comprising a computer that functions as a WWW game contents server and is connected with a plurality of player terminals via the communication network to allow mutual communication therewith, the player terminal capable of executing a program for a virtual prize-obtaining game, and the game system being capable of providing, to a player, an actual prize that corresponds to a virtual prize obtained in the virtual prize-obtaining game. The system is specified by the following items (11)-(12):

(11) The computer comprises a game-progress-monitoring processor, prize-obtainment-rate-adjusting means, and a database provided in an appropriate storage medium and storing various kinds of information. The database stores a target prize-obtainment rate that is a target value of a ratio of a number of obtained prizes to a number of times the game is to be executed.

(12) The game-progress-monitoring processor obtains, in response to a request from one of the player terminals, game contents such as image data from the database and the prize-obtainment-rate-adjusting means, sends the game contents to the terminal that sent the request, and receives a game-end notification from the terminal that sent the request.

The game contents includes primary decision information indicating whether to allow or disallow obtainment of the virtual prize for the game being executed. The primary decision information is generated by the prize-obtainment-rate-adjusting means according to the target prize-obtainment rate. The primary decision information comprises obtainment-disallowing information for preventing obtainment of the virtual prize from succeeding regardless of how operation is carried out during the game, and obtainment-allowing information for allowing obtainment of the virtual prize to succeed depending on how the operation is carried out.

The game-end notification accompanies prize-obtainment information.

According to such a configuration, it becomes possible to, for example, enjoy a prize-obtaining game, which is usually provided in e.g. a game center, to be virtually enjoyed on e.g. a personal computer at home, and it becomes possible to adjust the prize-obtainment rate of the game.

### BRIEF DESCRIPTION OF DRAWINGS

FIG. 1 is a basic configuration diagram of an embodiment of a prize-obtaining game system using a communication network according to the present invention;

FIG. 2 is a diagram showing an example of a game screen according to the above-mentioned embodiment;

FIG. 3 is a process flowchart of a game-progress-monitoring processor according to the above-mentioned embodiment;

FIG. 4 is a diagram showing a prize-obtainment-rate-setting table within a database according to the above-mentioned embodiment;

FIG. 5 is a process flowchart of an information-obtaining processor within prize-obtainment-rate-adjusting means according to the above-mentioned embodiment;

FIG. 6 is a diagram showing a primary-decision-information reference table within a database according to the above-mentioned embodiment;

FIG. 7 is a process flowchart of a database-updating processor within the prize-obtainment-rate-adjusting means according to the above-mentioned embodiment;

FIG. 8 is a process flowchart of a prize-obtainment-rate calculating processor within the prize-obtainment-rate-adjusting means according to the above-mentioned embodiment;

FIG. 9 is a basic configuration diagram of a prize-obtaining game system of a first modified example according to the present invention;

FIG. 10 is a diagram showing a prize-obtainment-rate-setting table within a database according to the above-mentioned first modified example;

FIG. 11 is a basic configuration diagram of a prize-obtaining game system of a second modified example according to the present invention; and

FIG. 12 is an diagram for explaining the way of generating primary decision information according to the above-mentioned second modified example.

### BEST MODE FOR CARRYING OUT THE INVENTION

==Outline of Disclosure==

An invention according to claim 1 of the present invention is a prize-obtaining game system using a communication network, the game system comprising a computer that functions as a WWW game contents server and is connected with a plurality of player terminals via the communication network to allow mutual communication therewith, the player terminal capable of executing a program for a virtual prize-obtaining game, and the game system being capable of providing, to a player, an actual prize that corresponds to a virtual prize obtained in the virtual prize-obtaining game. The system is specified by the following items (11)-(12):

(11) The computer comprises a game-progress-monitoring processor, prize-obtainment-rate-adjusting means, and a database provided in an appropriate storage medium and storing various kinds of information. The database stores a target prize-obtainment rate that is a target value of a ratio of a number of obtained prizes to a number of times the game is to be executed.

(12) The game-progress-monitoring processor obtains, in response to a request from one of the player terminals, game contents such as image data from the database and the prize-obtainment-rate-adjusting means, sends the game contents to the terminal that sent the request, and receives a game-end notification from the terminal that sent the request.

The game contents includes primary decision information indicating whether to allow or disallow obtainment of the virtual prize for the game being executed. The primary decision information is generated by the prize-obtainment-rate-adjusting means according to the target prize-obtainment rate. The primary decision information comprises obtainment-disallowing information for preventing obtainment of the virtual prize from succeeding regardless of how operation is carried out during the game, and obtainment-allowing information for allowing obtainment of the virtual prize to succeed depending on how the operation is carried out.

The game-end notification accompanies prize-obtainment information.

According to the invention of claim 1, when a game is started in a player terminal, primary decision information about the game being executed is generated with the prize-obtainment-rate-adjusting means, and the information is transmitted to the above-mentioned player terminal via the game-progress-monitoring processor. This primary decision information is information on whether to allow or disallow obtainment of a virtual prize for the game. More specifically, it comprises obtainment-disallowing information for preventing obtainment of the virtual prize from succeeding regardless of how operation is carried out during the game, and obtainment-allowing information for allowing obtainment of the virtual prize to succeed depending on how the operation is carried out. Either one of the above is assigned and generated according to a target prize-obtainment rate.

Then, if the player terminal receives the obtainment-disallowing information, it is made so that, as far as the game being executed is concerned, the prize obtainment will always fail regardless of how the player carries out the operation. On the other hand, if the obtainment-allowing information is received, success/failure of the prize obtainment will be determined according to the details of operation.

Accordingly, the above-mentioned actually-achieved prize-obtainment rate will always be smaller than the above-mentioned target prize-obtainment rate, to an extent of occurrence of failures due to how the operation is carried out on the player terminal. Therefore, it becomes possible to certainly keep the actually-achieved prize-obtainment rate equal to or below the target prize-obtainment rate.

An invention set forth in claim 2 is a prize-obtaining game system using a communication network according to claim 1, comprising the following items (21)-(23):

(21) The prize-obtainment-rate-adjusting means is related to a primary-decision-information reference table that is established in advance according to the target prize-obtainment rate. The primary-decision-information reference table stores the primary decision information for a predetermined number of times the game is to be executed in relation to the target prize-obtainment rate, the primary decision information being correlated with respective index numbers in a non-overlapping manner. Either the obtainment-disallowing information or the obtainment-allowing information being allotted to the primary decision information at the target prize-obtainment rate.

(22) The prize-obtainment-rate-adjusting means uses the target prize-obtainment rate and the index number in relation to the game being executed to read the primary decision information from the primary-decision-in-formation reference table and generate the primary decision information.

(23) Each of the index numbers is used only once in the predetermined number of times the game is to be executed.

According to the invention of claim 2, the above-mentioned prize-obtainment-rate-adjusting means can refer to the above-mentioned primary-decision-information reference table, which is stored in advance, using the index number and the target prize-obtainment rate for the game being executed, and can obtain and generate the primary decision information relating to the above-mentioned game from this table. That is, it is possible to generate the primary decision information simply by referring to the above-mentioned table. Therefore, it becomes possible to carry out a process equivalent to the above-mentioned random number generation in an extremely short amount of time, and significantly reduce the burden in calculation therefor.

An invention set forth in claim 3 is a prize-obtaining game system using a communication network according to claim 1, comprising the following items (31)-(33):

(31) The target prize-obtainment rate is adjustably set to have given values provided at a predetermined interval.

(32) The prize-obtainment-rate-adjusting means comprises random-number-generating means that generates random numbers for every game being executed. The random numbers are comprised of non-overlapping numbers in a quantity obtained by dividing the number 100 by the interval expressed as a value in percentage.

(33) The prize-obtainment-rate-adjusting means comprises random-number-correlating means, and the random-number-correlating means correlates, to each of the random numbers, the primary decision information of either the obtainment-disallowing information or the obtainment-allowing information to the primary decision information at a ratio of the target prize-obtainment rate.

According to the invention of claim 3, the above-mentioned prize-obtainment-rate-adjusting means generates, with the random-number-generating means, a random number for every game being executed. Also, it can generate primary decision information relating to the above-mentioned game by obtaining the primary decision information corresponding to the generated random number from the random-number-correlating means. That is, since the primary decision information is generated according to the random number, it becomes possible to significantly reduce the periodicity of the primary decision information relating to the order of executing the game.

An invention set forth in claim 4 is a prize-obtaining game system using a communication network according to claim 3, comprising the following items (41)-(43):

(41) The random numbers are comprised of integers that start from 0 and are provided in the quantity.

(42) The random-number-correlating means correlates the obtainment-allowing information to random numbers having a numerical value that is below a threshold, and correlates the obtainment-disallowing information to random numbers having a numerical value that is equal to or above the threshold.

(43) The threshold is obtained by dividing a value of the target prize-obtainment rate expressed in percentage by a value of the interval expressed in percentage.

According to the invention of claim 4, the random-number-correlating means correlates the obtainment-allowing information to random numbers below the threshold, and on the other hand, correlates the obtainment-disallowing information to random numbers equal to or above the threshold, taking the above-mentioned threshold as a border. Therefore, it becomes possible to easily grasp the correspondence between the generated random numbers and the primary decision information, and easily obtain the primary decision information. On the other hand, since the threshold is obtained by dividing a value of the target prize-obtainment rate expressed in percentage by a value of the interval expressed in percentage, it is possible to easily obtain it through calculation. Therefore, it becomes possible to simplify the process of generating the primary decision information.

An invention set forth in claim 5 is a prize-obtaining game system using a communication network according to either one of claims 2 through 4, comprising the following items (51)-(53):

(51) The database separately stores, as the target prize-obtainment rate, a final target obtainment rate that is a target to be finally realized, and a temporary target obtainment rate that is a short-term target for realizing the final target obtainment rate.

(52) The prize-obtainment-rate-adjusting means comprises a database-updating processor that updates, according to the prize-obtainment information, a number of already-obtained prizes and a total number of times the game has been executed which are stored in the database, and a prize-obtainment-rate-calculating processor that calculates and updates the temporary target prize-obtainment rate, taking the predetermined number of times the game is to be executed as one cycle.

(53) The prize-obtainment-rate-calculating processor calculates an actually-achieved prize-obtainment rate every time the cycle is finished, updates the temporary target prize-obtainment rate for the next cycle to be equal to the final target prize-obtainment rate if the actually-achieved prize-obtainment rate is larger than the final target prize-obtainment rate stored in the database in advance, and on the other hand, updates the temporary target prize-obtainment rate for the next cycle to be larger than the final target prize-obtainment rate if the actually-achieved prize-obtainment rate is equal to or smaller than the final target prize-obtainment rate.

According to the invention of claim 5, the actually-achieved prize-obtainment rate is calculated and the difference from the final target prize-obtainment rate is comprehended every time the above-mentioned cycle is finished, and the temporary target prize-obtainment rate for the next cycle is made to be equal to the final target prize-obtainment rate if the actually-achieved prize-obtainment rate is larger than the final target prize-obtainment rate, and on the other hand, the temporary target prize-obtainment rate for the next cycle is made to be larger than the final target prize-obtainment rate if the actually-achieved prize-obtainment rate is equal to or smaller than the final target prize-obtainment rate. Therefore, in the former case, the actually-achieved prize-obtainment rate for the next cycle will certainly be smaller than the final target prize-obtainment rate, whereas in the latter case, the possibility for the actually-achieved prize-obtainment rate for the next cycle to become larger than the final target prize-obtainment rate will increase. Therefore, in either case, adjustment will be made to compensate for the above-mentioned difference.

Therefore, it becomes possible to prevent the actually-achieved prize-obtainment rate from deviating significantly lower than the final target prize-obtainment rate, and players will be able to obtain prizes at a ratio substantially at the final target prize-obtainment rate.

An invention set forth in claim 6 is a prize-obtaining game system using a communication network according to claim 5, wherein the actually-achieved prize-obtainment rate is calculated by dividing the number of already-obtained prizes in the cycle by the predetermined number of times the game is to be executed.

According to the invention of claim 6, since the actually-achieved prize-obtainment rate is calculated as explained above, the temporary target prize-obtainment rate for the next cycle will be calculated and set by comparing the actually-achieved prize-obtainment rate for the immediately preceding cycle with the final target prize-obtainment rate. Therefore, the immediately preceding circumstances of obtainment will be largely reflected onto the obtainment rate for the next cycle. For example, if not so many prizes were obtained in the immediately previous cycle, it will become possible to make many prizes be obtained in the next cycle, whereas if many prizes were obtained in the immediately previous cycle, obtainment of prizes will be suppressed in the next cycle. That is, since the difficulty in prize obtainment changes in a short period, it becomes possible to prevent a situation in which it becomes difficult to obtain prizes for a long period of time.

An invention set forth in claim 7 is a prize-obtaining game system using a communication network according to either claims 5 or 6, wherein: prize-obtainment-rate information including the final target prize-obtainment rate, the temporary target prize-obtainment rate, the number of already-obtained prizes, and the total number of times the game has been executed is stored in the database correlated with a game code for every kind of game; and a search for the prize-obtainment-rate information after starting a game is done by taking the game code as a key, the game code being specified according to the kind of game input from the player terminal at the time of starting the game.

According to the invention of claim 7, since the above-mentioned prize-obtainment-rate information is stored in correlation with the game code for every kind of game, it becomes possible to adjust the prize-obtainment rate for every kind of game, and thus perform precise adjustment.

### EXAMPLES

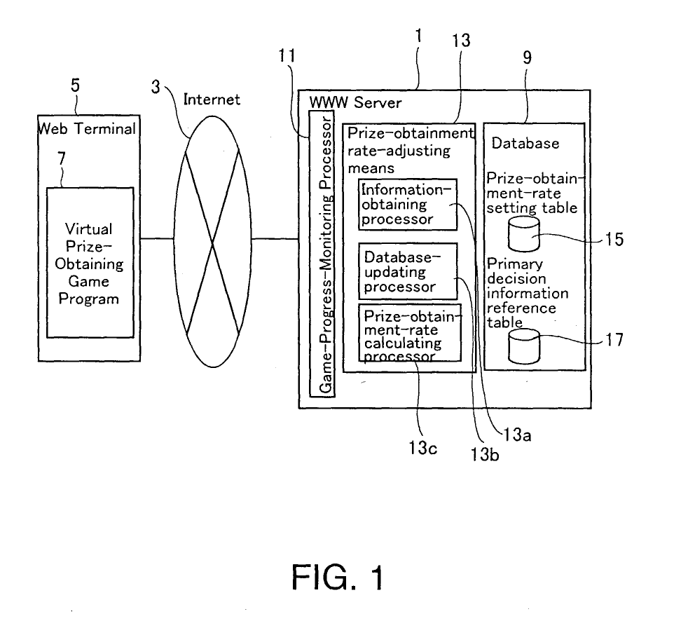

FIG. 1 shows a basic configuration of an embodiment of a prize-obtaining game system using a communication network according to the present invention. This system comprises a computer functioning as WWW server 1, and a plurality of Web terminals 5 (although only one is shown in FIG. 1) functioning as player terminals and connected to the server 1 via the Internet 3.

The Web terminal 5 is an operation terminal comprising, in addition to communication means enabling communication with the Internet 3, screen-displaying means, operation-input means, and data-storing-and-computing means, which are the minimum requirements for carrying out the virtual prize-obtaining game. For example, a personal computer or a mobile communication terminal, such as a cellular phone or a PDA comprising the data-storing-and-computing means, are applicable as the terminal 5. To the Web terminal 5, a virtual prize-obtaining game program 7 is installed according to, for example, distribution from the WWW server 1 as explained later. The terminal 5 executes this virtual prize-obtaining game program 7 according to a command input with the operation-input means by the player, and realizes the virtual prize-obtaining game on its screen.

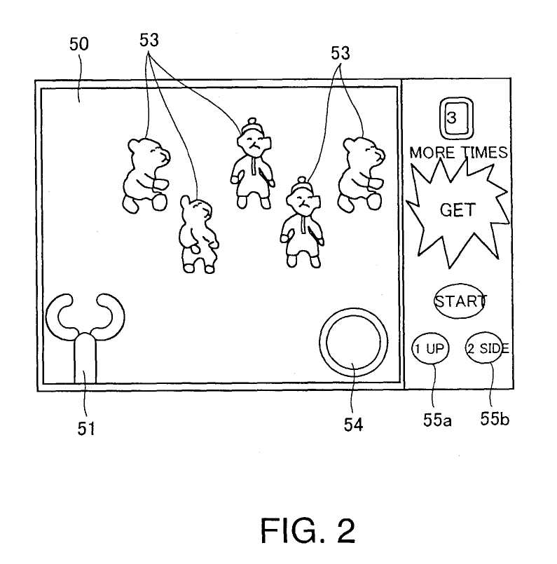

FIG. 2 shows a game screen 50 of a virtual catcher game as an example of the virtual prize-obtaining game. This virtual catcher game is played by making a manipulator 51, which is displayed on the bottom left of the screen, move using the above-mentioned operation-input means, and making the final stopping position of the manipulator match on a virtual prize 53. If the final stopping position is within a predetermined area from the center of the virtual prize 53, it is deemed that the virtual prize 53 has been obtained by the manipulator 51. Then, information indicating this prize obtainment is transmitted to a prize-delivering dealer via the above-mentioned WWW server 1, and an actual prize corresponding to the virtual prize is delivered to the player at a later date.

The WWW server 1 shown in FIG. 1 is a server provided on the WWW (World Wide Web), i.e., the Internet 3. The server 1 manages a game site that provides services regarding various virtual games, in addition to the virtual prize-obtaining game, to the Web terminal 5 that has accessed the server via the Internet 3. More specifically, the WWW server 1 functions as a WWW game-contents server that distributes, to each of the accessing Web terminals 5, game contents necessary for executing the virtual games. The server 1 realizes the virtual prize-obtaining game on the Web terminal 5, in cooperation with the above-mentioned virtual prize-obtaining game program 7 having been installed to the Web terminal 5 through distribution.

The WWW server 1 comprises: a database 9 etc. that stores various kinds of information such as image data necessary for executing the above-mentioned virtual game; a game-progress-monitoring processor 11 that obtains the above-mentioned game contents such as the image data from the database 9 etc. and transmits the contents, in response to a request from the Web terminal 5; prize-obtainment-rate-adjusting means 13 for adjusting the obtainment rate of the above-mentioned virtual prizes; and not-shown prize-obtainment-information-notifying means that notifies the above-mentioned prize-obtainment information received from the above-mentioned game-progress-monitoring processor 11 to the prize-delivering dealer.

The player wishing to play the virtual prize-obtaining game will: start a Web browser installed to the Web terminal 5; access a homepage of the game site managed by the WWW server 1 via the Internet 3 using the Web browser; carry out predetermined authentication procedures by, for example, sending his/her user ID and password to the WWW server 1 using a login function provided on the homepage, and also carry out a procedure for designating the method of paying for e.g. the game fees; and obtain screen-configuration data of a game-selection page from the WWW server 1.

The game-selection page provides several kinds of virtual prize-obtaining games, and shows prize groups, each of which consisting of several kinds of virtual prizes and correlated to each kind of virtual prize-obtaining game. The player designates a game by, for example, clicking on a section in which the virtual prize-obtaining game that he/she wants to play or in which the virtual prize-obtaining game including the prize that he/she wants to get is displayed, using the operation-input means. Then, the Web terminal 5 transmits, to the WWW server 1, a notification requesting distribution of the game and accompanying a game code for specifying the kind of virtual prize-obtaining game that has been designated.

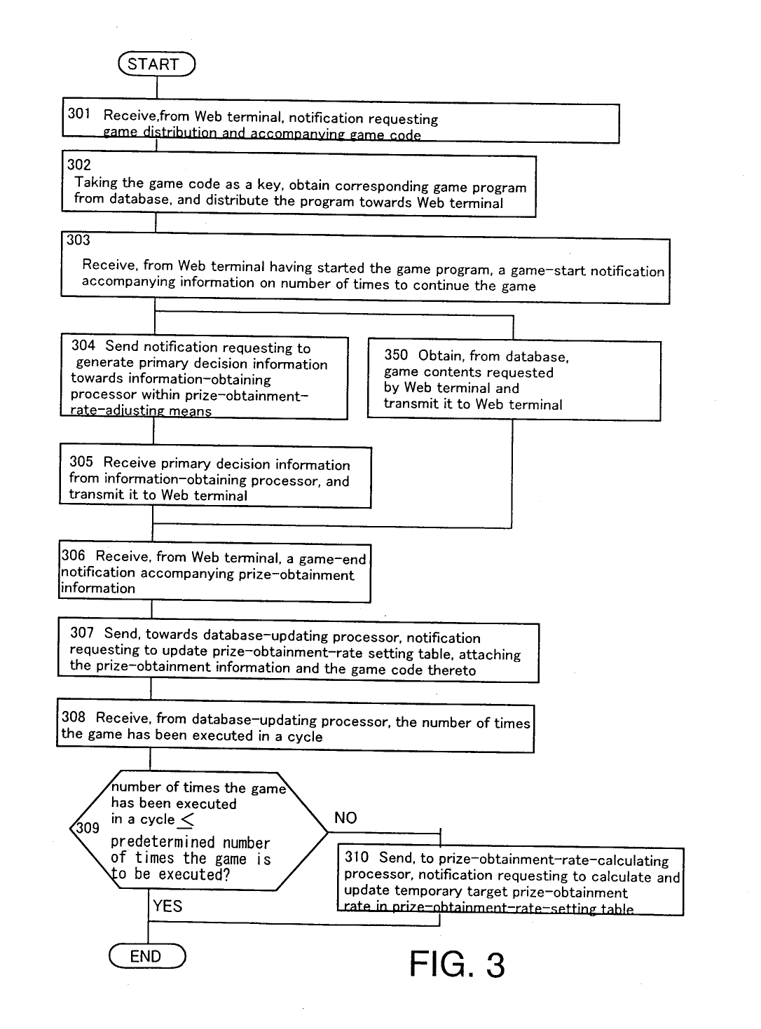

A process flow of the game-progress-managing processor 11 within the WWW server 1 that has received the game-distribution-requesting notification is shown in FIG. 3. If the virtual prize-obtaining game program 7 corresponding to the above-mentioned game code has not been stored in the above-mentioned Web terminal 5 yet, the game-progress-managing processor 11 obtains the above-mentioned game program 7 corresponding to the above-mentioned game code from the database 9 etc., and distributes the program towards the Web terminal 5 in a format such as Java applet (trademark) (302).

When downloading of the virtual prize-obtaining game program 7 is finished, the player enters the number of times to continue the game, which indicates the number of times of continuously playing the game in series at a time (three times is entered in FIG. 2), using the operation-input means of the Web terminal 5, and starts the above-mentioned game program 7 by, for example, clicking on a game-start button shown on the screen. At this time, a game-start notification accompanying information about the number of times to continue the game is transmitted from the Web terminal 5 to the WWW server 1 (303). Having received this notification, the game-progress-monitoring processor 11 will appropriately obtain from the database 9 etc. the game contents that are appropriately requested from the Web terminal 5 and transmit the contents to the Web terminal 5 to assist the above-mentioned game program 7, until it receives a game-end notification for the series of games played continuously (350).

As explained above, the virtual prize-obtaining game program 7 is programmed to enable one to play by manipulating, with the above-mentioned operation-input means, the manipulator 51 shown on the screen and matching the final stopping position of the manipulator on the virtual prize. As shown in FIG. 2, on the above-mentioned game screen 50, several images of the virtual prizes 53 are shown on appropriate positions. The image of the manipulator 51 displayed on the bottom left of the screen can be moved once in the upward direction and once in the rightward direction by manipulating, with the operation-input means, the two direction buttons 55a, 55b shown on the bottom right of the screen. A decision is made on whether or not the final stopping position of the above-mentioned manipulator 51 is within a predetermined area from the center of a virtual prize 53. According to the result of this decision and later-explained primary decision information that the Web terminal 5 receives, determination is made on whether or not the virtual prize 53 is to be awarded to the player playing that game. After this determination, displaying is made on the above-mentioned screen 50 showing either a moving image indicating a success in obtainment where the manipulator 51 grasps the virtual prize 53 and drops it into an outlet 54, or a moving image indicating a failure in obtainment where the manipulator fails to grasp the virtual prize 53, according to the determination. After this sequence is repeated for the above-mentioned number of times to continue the game and a series of games is finished, the Web terminal 5 sends, towards the WWW server 1, the game-end notification by attaching prize-obtainment information about, for example, the number of prizes obtained through the series of games.

The above-mentioned primary decision information is information on whether or not to allow obtainment of virtual prizes 53 to each of the games. The information includes obtainment-disallowing information that will prevent obtainment of virtual prizes from succeeding regardless of how the player operates the game, and obtainment-allowing information that will allow obtainment of virtual prizes to succeed depending on how the operation is made. Either one of the above information will be sent to each game. More specifically, if the primary decision information that the Web terminal 5 receives is the obtainment-disallowing information, the above-mentioned game program 7 will determine not to allow obtainment of virtual prizes 53 for the game being executed, regardless of the decision result of the final stopping position of the manipulator 51, and, according to this determination, the program will select the moving image for the above-mentioned obtainment failure as the moving image and will display it on the screen. On the other hand, if the obtainment-allowing information is received, the determination will differ depending on the above-mentioned decision result. That is, it will be deemed that a virtual prize 53 has been obtained if the final stopping position of the manipulator 51 is within the above-mentioned predetermined area, and the moving image indicating obtainment success will be displayed; and it will be deemed that obtainment has failed if the position is outside the area, and the moving image indicating obtainment failure will be displayed.

As the game-start notification is received, a generation-requesting notification for the primary decision information is immediately sent from the above-mentioned game-progress-monitoring processor 11 to the above-mentioned prize-obtainment-rate-adjusting means 13 (304), as shown in FIG. 3. Then, an information-obtaining processor 13a in the prize-obtainment-rate-adjusting means 13 refers to both the prize-obtainment-rate-setting table 15 and the primary-decision-information reference table 17 stored in the database 9, and generates the primary decision information for the number of times to continue the game, for the above-mentioned series of games.

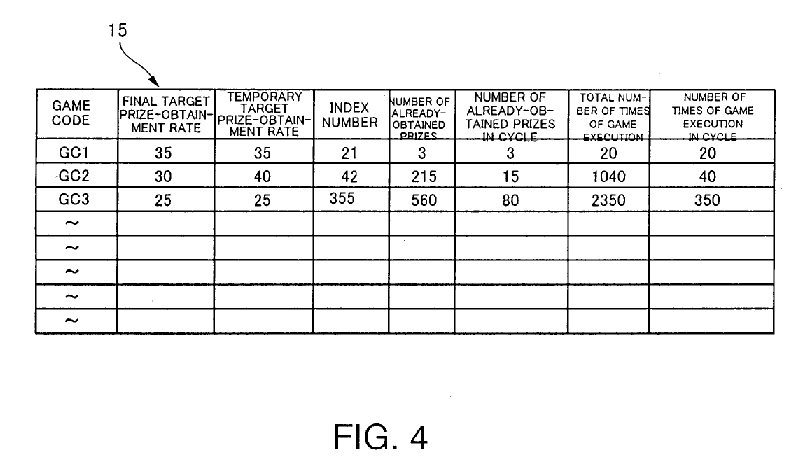

The prize-obtainment-rate-setting table 15 sets the prize-obtainment rate for each kind of virtual prize-obtaining game. That is, the table 15 sets a rate for assigning the obtainment-allowing information and the obtainment-disallowing information in the above-mentioned primary decision information. As shown in FIG. 4, on this table 15, prize-obtainment-rate information necessary for setting the prize-obtainment rate is recorded, associated with each kind of virtual prize-obtaining game, i.e., with each of the game codes.

As this prize-obtainment-rate information, there are: a final target prize-obtainment rate; a temporary target prize-obtainment rate; an index number; a number of already-obtained prizes; a number of already-obtained prizes in a cycle; the total number of times a game has been executed; and the total number of times a game has been executed in a cycle. The prize-obtainment rate is defined by a value obtained by dividing the number of already-obtained prizes by the number of times a game has been executed, expressed as a percent (also written as percentage). The final target prize-obtainment rate is the target of the prize-obtainment rate to be finally achieved. The final target prize-obtainment rate is determined and entered by the game-site manager by considering the prize cost and the game fee so that it would be economically profitable.

The temporary target prize-obtainment rate is directly used for assigning the above-mentioned primary decision information. That is, the temporary target prize-obtainment rate determines the ratio of whether either the above-mentioned obtainment-allowing information or the obtainment-disallowing information is to be generated. The temporary target prize-obtainment rate is calculated and updated, as explained later, every time when a cycle, which consists of a predetermined number of times a game is to be executed, is finished. This rate is used to prevent occurrence of a situation where the actually-achieved prize-obtainment rate, which is the actually-achieved value of the prize-obtainment rate, deviates from the above-mentioned final target prize-obtainment rate.

The index number is a counter indicative of the ordinal number, within the cycle, of the game being executed. It is used upon searching for the primary decision information relating to the game being executed from the later-explained primary-decision-information reference table. For this reason, the index number is incremented and updated every time it is used to search for the primary decision information for the game being executed, as explained later.

The number of already-obtained prizes is the cumulative number of prizes having been obtained in the virtual prize-obtaining game up to now. The number of already-obtained prizes in a cycle indicates the number of prizes that have been obtained in a cycle, and is reset to zero when the cycle is finished. The total number of times a game has been executed is the number of times this kind of game has been executed up to now. The total number of times a game has been executed in a cycle indicates the number of times this kind of game has been executed up to now in this cycle, and is reset to zero when the cycle is finished.

Such prize-obtainment-rate information will be explained in detailed with reference to FIG. 4. For example, a virtual prize-obtaining game of a certain kind of game correlated to the game code GC-2 is set so that the final target prize-obtainment rate is 30%, and the game has been executed 1040 times and 215 prizes have been obtained up to now. The predetermined number of times a game is to be executed for a cycle is set to be 1000 times; therefore, presently, the first cycle has been finished and the game is in the second cycle. In the second cycle, the game has been executed 40 times and 15 prizes have been obtained up to now. Currently, a series of games, in which the number of times to continue the game is three, is being executed. Thus, obtainment and updating of the index number for the above-mentioned series of games has been made as will be explained later on; and the index number is 42 and is larger than the above-mentioned 40 times that have already been executed, which is the number of times the game has been executed in the cycle. The number of prizes obtained is 200 for the first cycle and the actually-achieved prize-obtainment rate therefor is 20%. Thus, in order to compensate for the deviation between this and the above-mentioned target prize-obtainment rate of 30%, the temporary target prize-obtainment rate for the second cycle is set at 40%, which is higher than the target prize-obtainment rate.

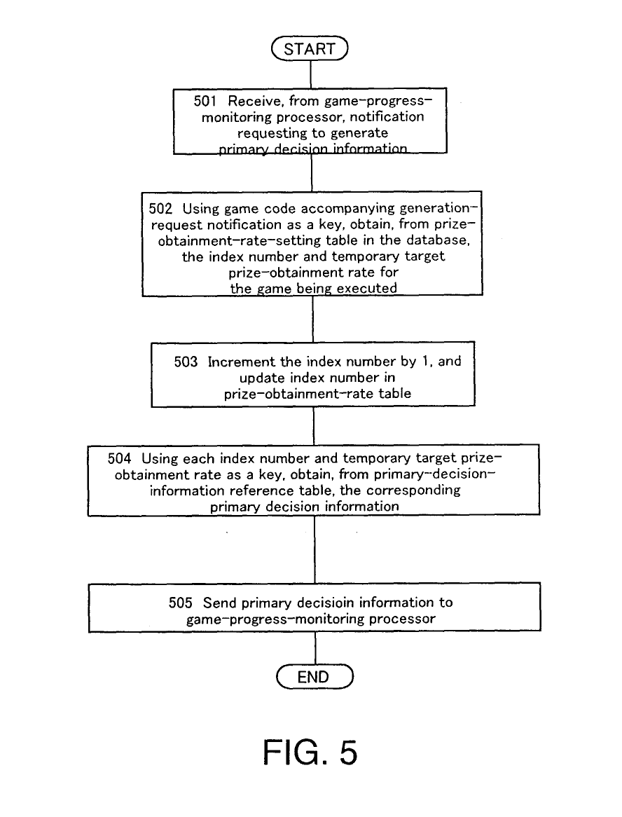

A process flow of the information-obtaining processor 13a is shown in FIG. 5. Having received the generation-requesting notification for the above-mentioned primary decision information, the information-obtaining processor 13a obtains, from the above-mentioned prize-obtainment-rate-setting table 15, the index number and the temporary target prize-obtainment rate corresponding to the game code accompanying the generation-requesting notification (502), increments the above-mentioned index number by one, and updates the prize-obtainment-rate-setting table 15 (503). This obtainment and updating (502) (503) is repeated for the above-mentioned number of times to continue the game, and index numbers amounting to the number of times to continue the game and used for the above-mentioned series of games are obtained. Note that until this repetitive obtainment and updating is completed, obtainment and updating of index numbers by other Web terminals is prohibited.

Then, taking the temporary target prize-obtainment rate and each of the index numbers as keys, the primary decision information for each of the games in the above-mentioned series is obtained from the primary-decision-information reference table 17 (504).

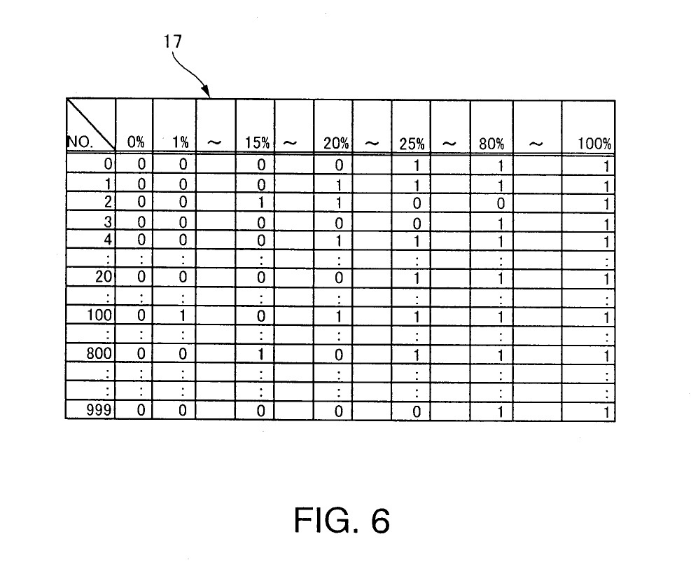

The primary-decision-information reference table 17 is shown in FIG. 6. This table 17 is formed of data configured by associating, without any overlap, the primary decision information, which is in a quantity equivalent to the predetermined number of times a game is to be executed, with all of the numerical values used for the index numbers. The above-mentioned obtainment-allowing information is allotted to the primary decision information at a predetermined rate, and to the rest of the primary decision information, the obtainment-disallowing information is allotted. This predetermined rate is arranged in advance within a range where there is a possibility that the above-mentioned temporary target prize-obtainment rate will be set. For example, in the present embodiment, the rate is arranged in 1% increments throughout a range of from 0% to 100% as illustrated. In the figure, 0 indicates the obtainment-disallowing information and 1 indicates the obtainment-allowing information. For example, in case the rate is 20%, among the 1000 index numbers from 0 to 999, 1s will be allotted to 200 of the index numbers, and 0s will be allotted to the rest of the 800 index numbers, in a random manner.

As shown in FIG. 5, the information-obtaining processor 13a refers to the primary decision information having the rate that matches the above-mentioned temporary target prize-obtainment rate in the primary-decision-information reference table 17, and reads the primary decision information for the above-mentioned index number (504). The processor repeats this for the number of times to continue the game, generates the pieces of the primary decision information for the above-mentioned series of games, and sends them to the game-progress-monitoring processor 11 (505). Having received these pieces of primary decision information, the game-progress-monitoring processor 11 transmits the primary decision information, one by one, to the Web terminal 5 while each of the games in the series is being executed (305). The primary decision information is used for the above-mentioned determination that the above-mentioned game program 7 performs in view of each of the games in the above-mentioned series. Then, according to each determination, the above-mentioned moving image for success or failure of obtainment is displayed on the screen.

When the above-mentioned series of games finishes accordingly, the game-end notification is transmitted from the Web terminal 5 to the game-progress-monitoring processor 11 (306). To this game-end notification, there is attached prize-obtainment information that includes: the number of times the game was continuously played for the series of games that has just finished; and the number of prizes finally obtained throughout this series of games. Having received this, the game-progress-monitoring processor 11 sends a notification requesting update of the above-mentioned prize-obtainment-rate-setting table 15 to a database-updating processor 13b within the prize-obtainment-rate-adjusting means 13 (307).

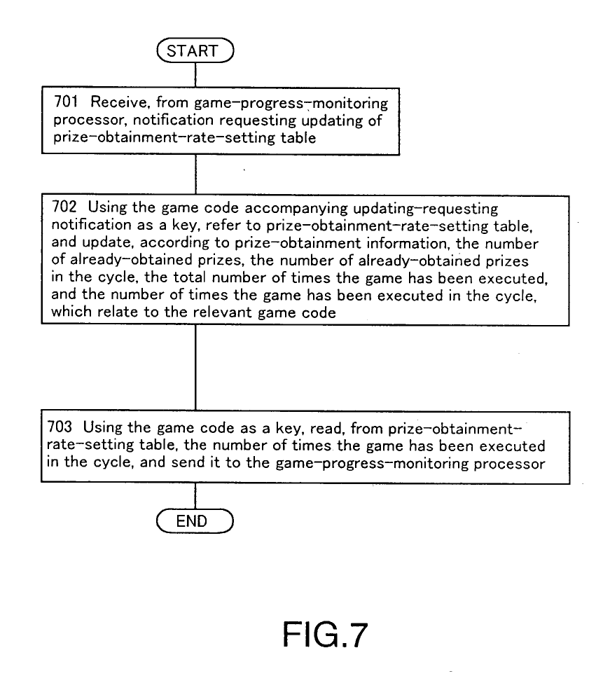

To this update-requesting notification, there are attached the above-mentioned prize-obtainment information and the game code. As shown in the process flow of FIG. 7, the database-updating processor 13b refers to the above-mentioned prize-obtainment-rate setting table 15 taking the game code as a key, and, according to the above-mentioned prize-obtainment information, it updates the number of already-obtained prizes, the number of already-obtained prizes in the cycle, the total number of times the game has been executed, and the number of times the game has been executed in the cycle, which relate to the relevant game code (702). Then, it sends the updated number of times the game has been executed in the cycle to the game-progress-monitoring processor 11 (703).

Having received this, the game-progress-monitoring processor 11 decides whether the above-mentioned cycle has completed, that is, whether or not the above-mentioned predetermined number of times the game is to be executed has been reached, according to the number of times the game has been executed in the cycle as shown in FIG. 3 (309).

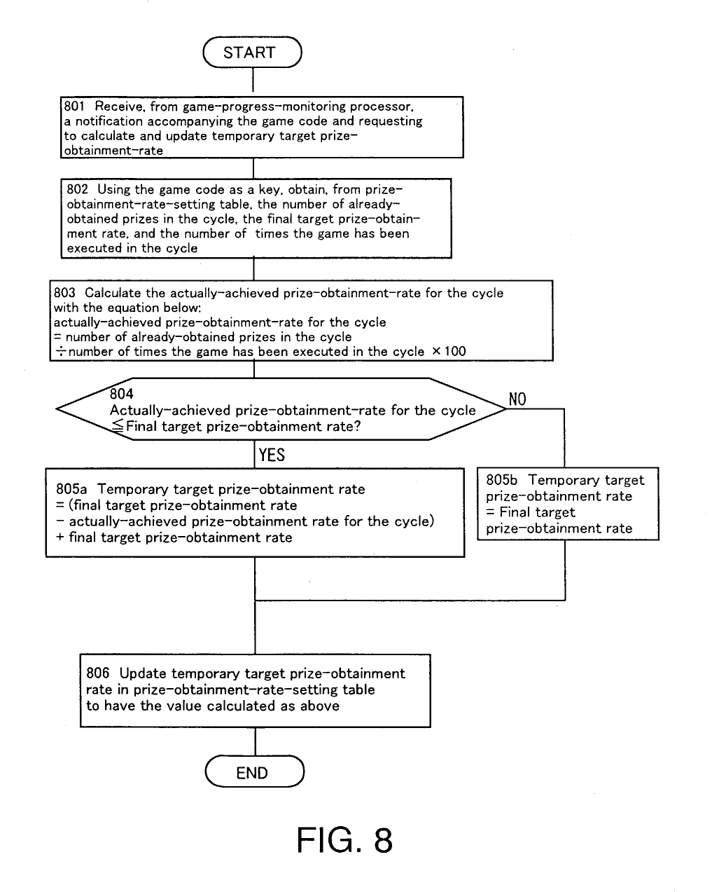

If it is decided that the number has been reached, in order to compensate for the difference in the actually-achieved prize-obtainment rate and the final target prize-obtainment rate, the processor 11 sends, to a prize-obtainment-rate-calculating processor 13c, a notification requesting to calculate and update the above-mentioned temporary target prize-obtainment rate (310). Then, as in the process flow shown in FIG. 8, the prize-obtainment-rate-calculating processor 13c refers to the final target prize-obtainment rate, the number of already-obtained prizes in the cycle, and the number of times the game has been executed in the cycle, taking the game code attached to the above-mentioned calculate-and-update-requesting notification (802). Then, the processor 13c divides the number of already-obtained prizes in the cycle by the number of times the game has been executed in the cycle, and it calculates the actually-achieved prize-obtainment rate for the cycle that has just been completed (803). Then, the processor 13c compares the actually-achieved prize-obtainment rate for that cycle with the above-mentioned final target prize-obtainment rate (804). If it is larger than the final target prize-obtainment rate, the processor 13c updates the temporary target prize-obtainment rate in the prize-obtainment-rate-setting table so that it is equal to the final target prize-obtainment rate (805b) (806); on the other hand, if it is equal to or lower than the final target rate, the processor 13c adds, to the final target prize-obtainment rate, the difference between the final target prize-obtainment rate and the actually-achieved prize-obtainment rate for the cycle and carries out updating (805a) (806). Note that this updated temporary target prize-obtainment rate will be used for a predetermined number of times of games to be executed for the next cycle.

On the other hand, if it is determined that the number has not been reached, calculation and updating of the above-mentioned temporary target prize-obtainment rate will not be carried out.

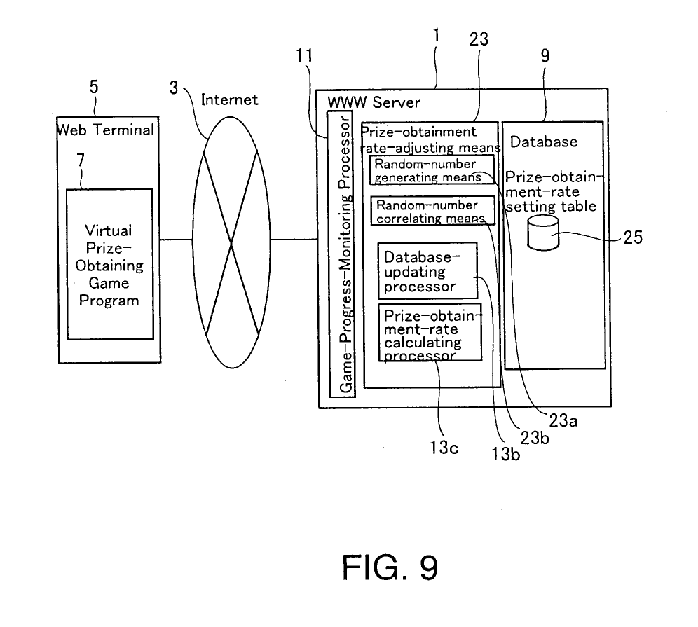

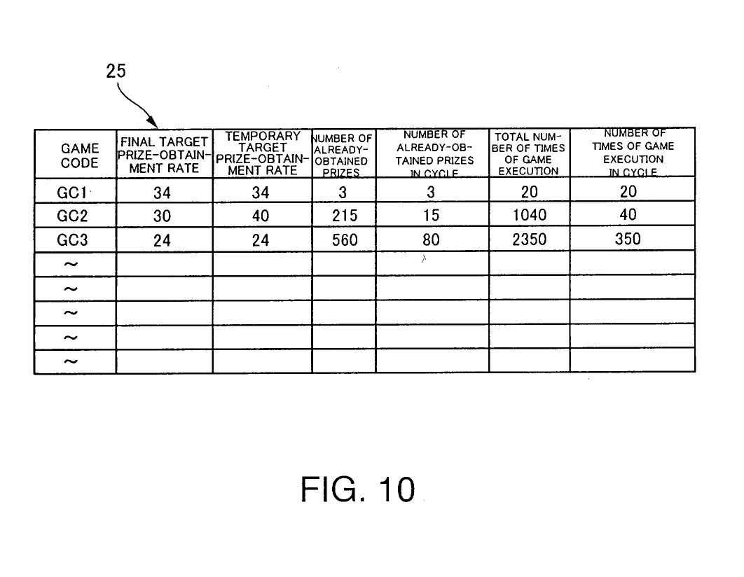

FIG. 9 is a basic configuration diagram of a prize-obtaining game system of a first modified example according to the present invention. FIG. 10 is a prize-obtainment-rate-setting table within a database according to this first modified example. Note that repeated explanation will be omitted by allotting the same reference characters to structural components that are the same as those in the above-mentioned embodiment.

The prize-obtainment-rate-adjusting means 13 in the above-mentioned embodiment uses a primary-decision-information reference table 17 for generating primary decision information with a low periodicity. The present, first modified example of the prize-obtainment-rate-adjusting means 23 differs in that it generates the primary decision information using random number generating means 23a etc. for further lowering the periodicity.

More specifically, instead of the primary-decision-information reference table 17 and the information-obtaining processor 13a provided in the above-mentioned embodiment, the prize-obtainment-rate-adjusting means 23 according to the present, first modified example comprises random number generating means 23a that generates random numbers for each game being executed, and random-number-correlating means 23b that correlates the primary decision information of either the above-mentioned obtainment-disallowable information or the obtainment-allowing information to each of these random numbers at a rate of the temporary target prize-obtainment rate. When a generation-requesting notification for primary decision information is sent from the game-progress-monitoring processor 11 to the above-mentioned prize-obtainment-rate-adjusting means 23, the prize-obtainment-rate-adjusting means 23 obtains the temporary target prize-obtainment rate from a prize-obtainment-rate-setting table 25 of FIG. 10 taking the game code as a key, and also, generates a random number for the game being executed and obtains the primary decision information corresponding to the generated random number from a group of primary decision information correlated to the above-mentioned random number. Accordingly, the means 23 generates primary decision information for the game being executed.

As illustrated, the above-mentioned prize-obtainment-rate-setting table 25 differs from the prize-obtainment-rate-setting table 25 of the above-mentioned embodiment only in the aspect that there are no index numbers recorded thereon. All other aspects are generally the same. More specifically, among the above-mentioned prize-obtainment-rate information, the final target prize-obtainment rate, the temporary target prize-obtainment rate, etc. are recorded. However, the temporary target prize-obtainment rate is made so that it cannot be set unless according to a predetermined interval. Therefore, if the calculated value of the temporary target prize-obtainment rate, which has been calculated etc. for updating at the time when the cycle has finished (refer to steps 805a, 805b), does not match a numerical value set at that interval, the calculated value will be rounded up/off to a numerical value set at that interval and being closest to the calculated value, and the temporary target prize-obtainment rate of the prize-obtainment-rate-setting table 25 will be updated. For example, if the calculated value that has been calculated for updating is 33.2% and the above-mentioned interval is 2%, the temporary target prize-obtainment rate will be rounded up to and set at 34%. Note that this interval may be a fixed value that is unchangeable from a value that has been set in advance at the time of system setup, or it can be made to undergo later changes using, for example, a maintenance terminal.

The random numbers generated by the above-mentioned random number generating means 23 are comprised of non-overlapping numbers and provided in a quantity that is obtained by dividing the number 100 by the above-mentioned interval expressed as a value in percentage, so that it is possible to generate primary decision information in correspondence with any temporary target prize-obtainment rate set at the above-mentioned interval. The random numbers in the present first modified example are comprised of integers starting from 0 and provided in the above-mentioned quantity. For example, if the above-mentioned interval is set at 2%, the above-mentioned random numbers will be comprised of integers from 0 to 49, which are 50 non-overlapping integers obtained by dividing 100 by 2.

Then, to each of the integers composing these random numbers, there is correlated either one of the above-mentioned primary decision information by the above-mentioned random-number-correlating means 23b at a ratio of the above-mentioned temporary target prize-obtainment rate. The present, first modified example adopts, as this random number generating means 23b, a method of carrying out correlation by providing ranges above and below a predetermined threshold. More specifically, it is made so that the obtainment-allowing information is correlated to random numbers having a numerical value that is below the threshold, and the obtainment-disallowing information is correlated to random numbers having a numerical value that is equal to or above the threshold. In order to assign the above-mentioned primary decision information at the ratio of the above-mentioned temporary target prize-obtainment rate, a value obtained by dividing the value of the above-mentioned temporary target prize-obtainment rate, which is expressed in percentage, by the value of the above-mentioned interval, which is expressed in percentage, is used as this threshold. For example, if the above-mentioned interval is 2% and the temporary target prize-obtainment rate is 34%, the above-mentioned threshold will have a value, 17, which is obtained by dividing 34 by 2. Then, to random numbers from 0 to 16, which are numerical values below 17, the obtainment-allowing information will be correlated. On the other hand, to random numbers from 17 to 50, which are numerical values equal to or above 17, the obtainment-disallowing information will be correlated. Accordingly, it is made possible to generate, to the number of times a-game is to be executed, the obtainment-allowing information at the ratio of the temporary target prize-obtainment rate, which is 34%.

Here, explanation will be made of the flow in generating the primary decision information with such prize-obtainment-rate-adjusting means 23.

As shown in step 304 of FIG. 3, when the generation-requesting notification for the primary decision information is sent from the game-progress-monitoring processor 11 to the above-mentioned prize-obtainment-rate-adjusting means 23, the random number generating means 23a in the prize-obtainment-rate-adjusting means 23 refers to the prize-obtainment-rate-setting table 25 stored in the database 9, and obtains the temporary target prize-obtainment rate corresponding to the game code. Next, the means 23a calculates the above-mentioned quantity of random numbers according to the above-mentioned interval. Note that, if the above-mentioned interval is the same for all game codes, it will be possible to omit the above-mentioned calculation for the quantity by storing the above-mentioned quantity in a predetermined memory in advance. Further, if the above-mentioned interval is different for every game code, by storing the above-mentioned quantity that has been once calculated for a game code in a predetermined memory associated with the game code, it will be possible to omit any further calculation by simply carrying out reading from the above-mentioned memory for a game that is executed later on and has the same game code.

When the calculation for the quantity is finished, the random number generating means 23a generates one random number among the integers in the above-mentioned quantity starting from 0. On the other hand, the random-number-correlating means 23b calculates the above-mentioned threshold for the game being executed, based on the above-mentioned interval and the temporary target prize-obtainment rate. Then, the random-number-correlating means 23b checks to see which side of this threshold the generated random number is in. If the random number is below the threshold, the means 23b will generate the obtainment-allowing information; on the other hand, if the random number is equal to or above the threshold, the means 23b will generate the obtainment-disallowing information. Note that, since this threshold changes only when either the temporary target prize-obtainment rate or the interval for each game code is updated, the threshold may be calculated and stored in a predetermined memory for each game code only when either one is updated, and at other times, the threshold may be obtained by referring to the memory using the game code as a key.

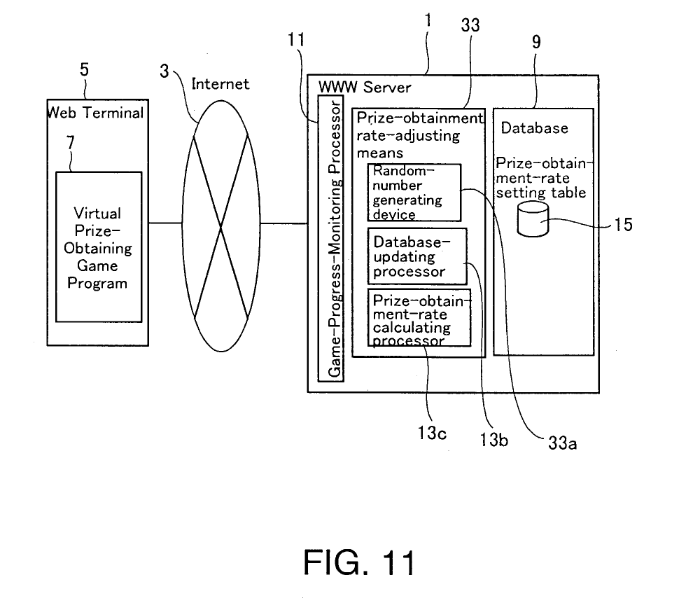

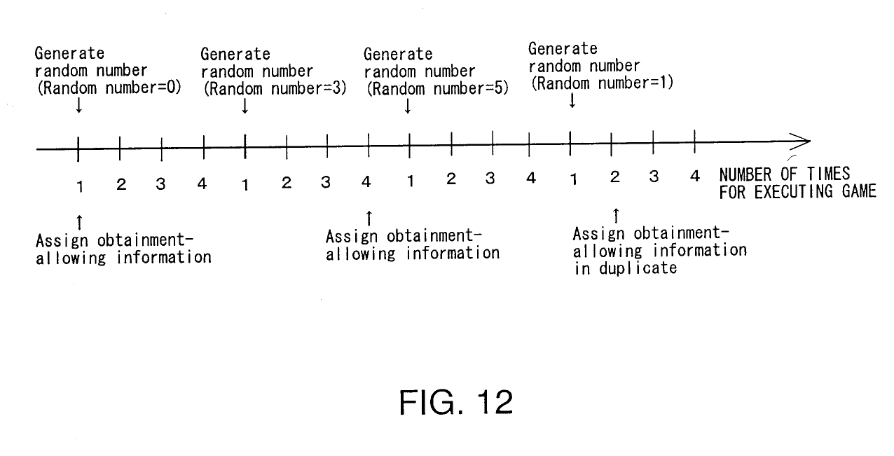

FIG. 11 is a basic configuration diagram of a prize-obtaining game system of a second modified example according to the present invention. FIG. 12 is an explanation diagram of a method for generating primary decision information according to the second modified example. This second modified example differs from the above-mentioned embodiment only in the method of generating the primary decision information with the prize-obtainment-rate-adjusting mean 33, and therefore, repeated explanation will be omitted by allotting the same reference characters to structural components that are the same as those in the above-mentioned embodiment.

In this method of generating the primary decision information, a random number is generated at intervals of every predetermined number of times a game is executed, and, according to the numerical value of the above-mentioned random number, it is determined to which game executed how many times ahead from the game that is being executed at the time of this random-number generation the obtainment-allowing information is to be assigned. By changing the sequence of the games to which the obtainment-allowing information is allotted according to this random number, the periodicity of the primary decision information is lowered.

Accordingly, the above-mentioned prize-obtainment-rate-adjusting means 33 comprises a random number generating device 33a that generates a random number in a predetermined period. On the other hand, this random number generating device 33a functions to assign obtainment-allowing information to a game that is to be executed a number of times after the game that was being executed at the time of generating the random number, the number of times being the numerical value of the random number.

In order to generate a random number to a game being executed at a ratio of the temporary target prize-obtainment rate to the number of times the game is to be executed, the above-mentioned predetermined period is set to be the reciprocal of the temporary target prize-obtainment rate. For example, if the temporary target prize-obtainment rate is 25%, the period will be 4, which is the reciprocal of 0.25. That is, as shown in FIG. 12, a random number will be generated once every four times the game is executed.

Further, the above-mentioned random number consists of integers starting from 0. As shown in FIG. 12, if the generated random number is 0, the obtainment-allowing information will be assigned to the game being executed at the time of generating the random number, which is the game executed 0 times ahead of when the random number-was generated.

Note that, although the upper limit of this random number may appropriately be set, it is preferable for the upper limit to be at least equal to or above a numerical value that is smaller by 1 than the period for generating the random number. For example, if the above-mentioned period is 4, it is preferable for the upper limit to be 3 or larger. This is done so as to provide the possibility of obtaining the obtainment-allowing information at least once in view of all of the games within the period.

By the way, it is possible to further modify the periodicity by adjusting this upper limit. For example, by making the upper limit larger, since the possibility of assigning the obtainment-allowing information will extend over to games in the next or further periods, it will be possible to further lower the periodicity of the primary decision information. However, in this case, as shown in FIG. 12, there is a possibility that two or more pieces of the obtainment-allowing information will be assigned in duplicate to a single game being executed. It is possible to cope with such a duplicate assignment by giving one of the two pieces of obtainment-allowing information to a game to be executed after the game being currently executed and subjected to duplicate assignment.

Incidentally, in order to periodically generate the above-mentioned random numbers at an interval of a predetermined number of times a game is to be executed, the above-mentioned random number generating device 33a uses the method of a DDA (digital differential analysis). The reason for using this method will be explained in short. For example, if the temporary target prize-obtainment rate is 25%, the reciprocal thereof will be 4, and therefore, by generating a random number at a ratio of once every four games, it will be possible to assign the obtainment-allowing information at a ratio of 25% in view of the number of times the game is to be executed. However, in a case where the temporary target prize-obtainment rate is 21%, it will be necessary to generate a random number at a ratio of once every 4.7619 times, which is the reciprocal of the above-mentioned rate. In such a case, it will not be possible to generate the above-mentioned random number at a ratio of 21% because there exists no digits to the right of the decimal point for the actual number of times for executing a game, and on the other hand, an error will be introduced if the digits to the right of the decimal point is rounded by, for example, rounding the number off. By using the above-mentioned DDA for such a case, it will become possible to generate a random number at a period of 21%.

Below, detailed explanation will be made of a procedure of generating random numbers with the DDA, through the use of specific numerical values. For example, in the case of periodically generating random numbers at a ratio of 21.1% in view of the number of times for executing a game, first, this rate is to be expressed as a fraction in which both the numerator and the denominator are integers. For example, in the case of 21.1%, this will be expressed as 211/1000. Then, as the number of times for executing the game increases one by one, the numerical value of the numerator is successively incremented, and a total value is calculated for each game being executed. When the total value becomes equal to or larger than the numerical value of the denominator, a random number is generated in the game that is being executed at the time the total value exceeded the denominator. Then, a value, which is obtained by adding the numerical value of the above-mentioned numerator to the remainder of subtracting the value of the denominator from the above-mentioned total value, will be taken as the total value for the game to be executed next. By repeating the above procedure thereafter and generating a random number every time the total number exceeds the numerical value of the denominator, the ratio of the number of times a random number is generated in view of the number of times for executing the game will get closer and closer to the above-mentioned temporary target prize-obtainment rate, as the number of times for executing the game increases.

For example, in the case where the temporary target prize-obtainment rate is 21.1%, the total value for the first game will be 211, and therefore, 211 will be added each time the game is executed. At the time of the fifth game, the total value will be 1055, that is, the total value will be equal to or above 1000, which is the numerical value of the above-mentioned denominator; therefore, a random number is generated during the fifth game. Then, the total value for the next sixth game will be 266, which is calculated by adding 211 to 55 being the remainder of subtracting 1000 from the above-mentioned 1055. By repeating the above procedure thereafter and generating a random number every time the total number becomes equal to or above 1000, the ratio of the number of times a random number is generated in view of the number of times for executing the game will get closer and closer to 21.1%, as the number of times for executing the game increases.

An embodiment of the present invention has been explained above. However, the present invention is not to be limited to such an embodiment, and it is possible to make modifications set forth below within the scope that does not depart from the gist of the present invention.

(a) In the present embodiment, the virtual prize-obtaining game program is distributed through the Internet. However, the configuration is not to be limited to the above. The way of carrying out the above-mentioned distribution may be done by supplying storage media such as CD-ROMs storing therein the above-mentioned game program.

(b) In the present embodiment, the various kinds of virtual prize-obtaining game programs and the image data that are to be requested from the Web terminals 5 are stored in the database that the above-mentioned WWW server 1 comprises. However, the configuration is not to be limited to the above. For example, the above-mentioned various kinds of virtual prize-obtaining game programs and the image data may be stored in different file servers connected via, for example, a LAN; that is, they may be subjected to distributed processing. In this case, only information such as an address list indicating where the above-mentioned game program and/or the image data are stored will be stored in the database of the WWW server 1. Then, when image data etc. is requested from a Web terminal 5, the WWW server 1 will refer to the above-mentioned address list indicating the storage location, and according to the storage address of the relevant image data, the server 1 may access the desired image data in the above-mentioned file server and obtain the data.

(c) In the present embodiment, the primary-decision-information reference table is used for generating the primary decision information. However, the configuration is not to be limited to the above. It is also possible to use a random-number-generating device that generates random numbers of 0 through 9, and generate the primary decision information by correlating either the above-mentioned obtainment-allowing information or the obtainment-disallowing information to each of the random numbers. Note that, instead of the above-mentioned random numbers of 0 through 9, it is possible to use random numbers consisting of rational numbers within a fixed range.

(d) In the present embodiment, the prize-obtainment-rate information is correlated to game codes for each kind of virtual prize-obtaining game. However, the configuration is not to be limited to the above. It is also possible to correlate a game code for every combination consisting of the above-mentioned kind of game and the above-mentioned prize group. In such a case, it becomes possible to adjust the prize-obtainment rate more precisely.

(e) In the present embodiment, the actually-achieved prize-obtainment rate, which is used for calculating and updating the temporary target prize-obtainment rate at the end of a cycle, is calculated by dividing the number of already-obtained prizes in the cycle by the above-mentioned predetermined number of times the game has been executed. However, the configuration is not to be limited to the above. For example, the above-mentioned actually-achieved prize-obtainment rate may be calculated by dividing the number of already-obtained prizes by the above-mentioned total number of times the game has been executed. In such a case, since the above-mentioned temporary target prize-obtainment rate will be calculated and set by always making a comparison between the actually-achieved prize-obtainment rate for the total number of times the game has been executed and the final target prize-obtainment rate, it will be possible to reduce the difference between both rates to a minimum.

(f) In the present embodiment, the above-mentioned primary-decision-information reference table is set in advance. However, the configuration is not to be limited to the above. It is also possible to reset the table by, for example, randomly changing the correspondence between the primary decision information and the index numbers each time the above-mentioned cycle is finished. Note that in such a case, the correspondence between the index numbers and the above-mentioned obtainment-allowing information or the obtainment-disallowing information becomes more random, and the players will be able to play a game without even slightly noticing the regularity in allowance/disallowance of obtainment.

(g) In the present embodiment, a virtual catcher game is exemplified as a virtual prize-obtaining game. However, any game may be applicable if it is possible to make a player aim at a predetermined target and allow obtainment of prizes according to the deviation from the target. For example, a shooting game may be applicable.

### INDUSTRIAL APPLICABILITY

As explained above, according to the invention set forth in claim 1, it is possible to, for example, certainly keep the actually-achieved prize-obtainment rate equal to or below a target prize-obtainment rate. Therefore, it becomes possible to prevent a situation in which prizes are endlessly obtained and the dealer is brought into economically unprofitable circumstances.

According to the invention set forth in claim 2, it is possible to, for example, carry out a process equivalent to generating random numbers for generating primary decision information in a short period of time and significantly reduce the burden in calculation. Therefore, the virtual prize-obtaining game can be carried out smoothly.

According to the invention set forth in claim 3, it is possible to, for example, significantly reduce the periodicity of the primary decision information resulting from the order of executing the game. Therefore, the player will be able to play a game without even slightly noticing the regularity in allowance/disallowance of obtainment.

According to the invention set forth in claim 4, it is possible to, for example, simplify the process of generating the primary decision information. Therefore, it becomes possible to reduce the burden in calculation required for executing the game.

According to the invention set forth in claim 5, it is possible to, for example, prevent the actually-achieved prize-obtainment rate from deviating significantly lower than the final target prize-obtainment rate, and players can obtain prizes at a ratio substantially at the final target prize-obtainment rate. Therefore, since the players can obtain prizes at a ratio substantially at the final target prize-obtainment rate, it becomes possible to avoid a situation in which the game becomes unpopular to the players due to difficulty in obtaining prizes.

According to the invention set forth in claim 6, it is possible to, for example, avoid a situation where it is difficult to obtain prizes for a long period of time. Therefore, it becomes possible to avoid a situation in which the game becomes unpopular to the players due to the above.

According to the invention set forth in claim 7, it is possible to, for example, precisely adjust the prize-obtainment rate.

1. A prize-obtaining game system using a communication network, said game system
comprising a computer that functions as a WWW game contents server and is connected with a plurality of player terminals via the communication network to allow mutual communication therewith, the player terminal capable of executing a program for a virtual prize-obtaining game, and
being capable of providing, to a player, an actual prize that corresponds to a virtual prize obtained in said virtual prize-obtaining game,
said game system being specified by the following items (11)-(12):
(11) said computer comprises
a game-progress-monitoring processor,
prize-obtainment-rate-adjusting means, and
a database provided in an appropriate storage medium and storing various kinds of information,
said database storing a target prize-obtainment rate that is a target value of a ratio of a number of obtained prizes to a number of times the game is to be executed; and
(12) said game-progress-monitoring processor
obtains, in response to a request from one of said player terminals, game contents such as image data from said database and said prize-obtainment-rate-adjusting means,
sends said game contents to the terminal that sent the request, and
receives a game-end notification from the terminal that sent the request,
said game contents including primary decision information indicating whether to allow or disallow obtainment of the virtual prize for the game being executed,
said primary decision information being generated by said prize-obtainment-rate-adjusting means according to said target prize-obtainment rate,
said primary decision information comprising
obtainment-disallowing information for preventing obtainment of the virtual prize from succeeding regardless of how operation is carried out during said game, and
obtainment-allowing information for allowing obtainment of the virtual prize to succeed depending on how said operation is carried out, and
said game-end notification accompanying prize-obtainment information.

2. A prize-obtaining game system using a communication network according to claim 1, comprising the following items (21)-(23):
(21) said prize-obtainment-rate-adjusting means is related to a primary-decision-information reference table that is established in advance according to said target prize-obtainment rate,
said primary-decision-information reference table storing the primary decision information for a predetermined number of times the game is to be executed in relation to said target prize-obtainment rate, said primary decision information being correlated with respective index numbers in a non-overlapping manner, and
either said obtainment-disallowing information or said obtainment-allowing information being allotted to said primary decision information at said target prize-obtainment rate;
(22) said prize-obtainment-rate-adjusting means uses the target prize-obtainment rate and the index number in relation to the game being executed to
read said primary decision information from said primary-decision-information reference table and
generate said primary decision information; and
(23) each of the index numbers is used only once in said predetermined number of times the game is to be executed.

3. A prize-obtaining game system using a communication network according to claim 1, comprising the following items (31)-(33):
(31) said target prize-obtainment rate is adjustably set to have given values provided at a predetermined interval;
(32) said prize-obtainment-rate-adjusting means comprises random-number-generating means that generates random numbers for every game being executed,
said random numbers being comprised of non-overlapping numbers in a quantity obtained by dividing the number 100 by said interval expressed as a value in percentage; and
(33) said prize-obtainment-rate-adjusting means comprises random-number-correlating means, and
said random-number-correlating means correlating, to each of said random numbers, the primary decision information of either said obtainment-disallowing information or said obtainment-allowing information to said primary decision information at a ratio of said target prize-obtainment rate.

4. A prize-obtaining game system using a communication network according to claim 3, comprising the following items (41)-(43):
(41) said random numbers are comprised of integers that start from 0 and are provided in said quantity;
(42) said random-number-correlating means
correlates the obtainment-allowing information to random numbers having a numerical value that is below a threshold, and
correlates the obtainment-disallowing information to random numbers having a numerical value that is equal to or above said threshold; and
(43) said threshold is obtained by dividing a value of said target prize-obtainment rate expressed in percentage by a value of said interval expressed in percentage.

5. A prize-obtaining game system using a communication network according to either one of claims 2 through 4, comprising the following items (51)-(53):
(51) said database separately stores, as the target prize-obtainment rate,
a final target obtainment rate that is a target to be finally realized, and
a temporary target obtainment rate that is a short-term target for realizing said final target obtainment rate;
(52) said prize-obtainment-rate-adjusting means comprises,
a database-updating processor that updates, according to said prize-obtainment information, a number of already-obtained prizes and a total number of times the game has been executed which are stored in said database, and
a prize-obtainment-rate calculating processor that calculates and updates said temporary target prize-obtainment rate, taking said predetermined number of times the game is to be executed as one cycle;
(53) said prize-obtainment-rate-calculating processor
calculates an actually-achieved prize-obtainment rate every time said cycle is finished,
updates the temporary target prize-obtainment rate for the next cycle to be equal to the final target prize-obtainment rate if said actually-achieved prize-obtainment-rate is larger than the final target prize-obtainment rate stored in the database in advance, and on the other hand,
updates the temporary target prize-obtainment rate for the next cycle to be larger than the final target prize-obtainment rate if said actually-achieved prize-obtainment rate is equal to or smaller than the final target prize-obtainment rate.

6. A prize-obtaining game system using a communication network according to claim 5, wherein said actually-achieved prize-obtainment rate is calculated by dividing the number of already-obtained prizes in said cycle by said predetermined number of times the game is to be executed.

7. A prize-obtaining game system using a communication network according to either claims 5 or 6, wherein:
prize-obtainment-rate information including
said final target prize-obtainment rate,
the temporary target prize-obtainment rate,
the number of already-obtained prizes, and
the total number of times the game has been executed
is stored in said database correlated with a game code for every kind of game, and
a search for the prize-obtainment-rate information after starting a game is done by taking the game code as a key, the game code being specified according to the kind of game input from the player terminal at the time of starting the game.
